(19) United States
(12) Patent Application Publication
(10) Pub. No.: US 2023/0177576 A1
(43) Pub. Date: Jun. 8, 2023

(54) INCOME-SHARING METHOD FOR ASKING AND ANSWERING QUESTIONS

(71) Applicant: ADIT OTOMOTIV SANAYI VE TICARET ANONIM SIRKETI, Bursa (TR)

(72) Inventor: Hasan AGAOGLU, Bursa (TR)

(73) Assignee: ADIT OTOMOTIV SANAYI VE TICARET ANONIM SIRKETI, Bursa (TR)

(21) Appl. No.: 17/542,550

(22) Filed: Dec. 6, 2021

(51) Int. Cl. G06Q 30/06

(52) U.S. Cl. CPC G06Q 30/0611; G06Q 30/0631

(57) ABSTRACT

An income-sharing method where service users can share their experiences among themselves for a price, and other users can also benefit from their shared experiences for a fee. In the income-sharing method, a user sends a question and an offer to a chosen expert, where the offer includes a price for the answer and other conditions. Once the expert and the user agree on the price for the answer and the other conditions, an answering process is initiated. When the question is a publicly asked question, users other than the expert and the user related to the question can pay a preview price to preview the answer given to the question and interact with the question, and an income arising from the preview of the other users is shared between the expert and the user related to the question according to the offer agreed upon.

### TECHNICAL FIELD

The present invention relates to a question-and-answer platform which includes methods for improving the quality of user-generated content through a question-and-answer service by enabling service users to request a direct answer to a question from another user.

More specifically, the invention includes an income-sharing method where service users can share their experiences among themselves for a price, and other users can also benefit from their shared experiences for a fee if they want to benefit from it, whereby both the person asking the question and the person answering the question can achieve benefits.

### BACKGROUND

Many online or web-based applications (i.e., apps) and services are based on contents that the service's end users create partially for some applications and almost entirely for others.

The success of such apps and services is highly dependent on their ability to attract and retain users who create content that can be shared with other users and who are willing to participate. A specific application or type of service, where this is valid, is an online question-and-answer service. Generally speaking, a question-and-answer service is a service that allows its end users to post questions, post answers to questions, or browse questions and answers posted by others. From the point of view of its users, the usefulness of a question-and-answer (i.e., Q&A) service or application largely depends on the extent to which meaningful answers are provided to the questions posted. In this sense, the question-and-answer service provides a platform wherein people can share about their areas of expertise and wherein people who are interested in these areas can share mutually. In the prior art, programs created for knowledge sharing are included in general question-and-answer applications such as forum pages for specific topics.

### SUMMARY OF THE INVENTION

Some embodiments of Q&A platforms include questions, answers, live streams, tutorials, blogs, and interactions with them. Users specify their areas of expertise and interests in the platform entry. Users can produce content according to their interests and areas of expertise, ask questions and answer these questions or create live streams.

The expert, who has the ability to answer any question, determines the price he/she wants to answer the question on the basis of a fixed price, difficulty level or method of negotiation on the system and notifies the person who will ask the question through a user profile. Users can follow and interact with people and categories in their feeds. Users can preview and interact with experts and questions based on category. Users can enter and update their education information, job resumes and interests in their profiles. Users can search for areas of expertise categorically and access questions and content streams related to these areas of expertise.

### BRIEF DESCRIPTION OF THE DRAWINGS

FIG. 1 is an exemplary sign-up interface (100) that enables users to sign up (register) with the application.

FIG. 2 is an illustration of an exemplary interface of the user login screen.

FIG. 3 is an example interface illustration of the user's home page.

FIG. 4 is an exemplary interface illustration of the expert's homepage.

FIG. 5 shows the exemplary interface for categories.

FIG. 6 shows the exemplary interface for categories.

FIG. 7 is a sample illustration of the interface where the user is prompted to ask the expert a question.

FIG. 8 is a sample interface for the content that the user wants to add to the question.

FIGS. 9,10, and 11 are examples of the question settings interface.

FIG. 12 is an exemplary illustration of the interface of summary of the question of the user.

FIG. 13 is a sample illustration of the expert's question summary interface.

FIG. 14 is an example of the interface where the expert is set to send new offers to the user.

FIG. 15 is an exemplary illustration of the interface of summary of the offer of the expert.

### DETAILED DESCRIPTION OF THE INVENTION

In the detailed description, an income-sharing method is disclosed where service users can share their experiences among themselves for a price, and other users can also benefit from their shared experiences for a price if they want to benefit from it, whereby both the person asking the question and the person answering the question can get benefits. The user is defined as the person who asks the question, and the expert is the person who answers the question. Users can select the user and category they want to ask questions and reach the recommended experts or other experts in the category that they choose. Users can upload content and media while they are asking questions. The content to be uploaded here is optional. While asking questions, users can publish privately or publicly. In this way, the user will be free to prevent or not prevent the questions from being viewed by other users. When asking questions, users can see the price and features requested by the expert and make an offer to the expert. Users can decide the difficulty level of the question and send it to the expert as an offer. In case of publicly asked questions, the user can donate the income arising from the income-sharing to charity. The sharing of the income is left entirely to the user's discretion, and different donation campaigns can be included in the program. Users can determine how many times the answer to the question can be previewed by other users and its price of previews, the income-sharing with the expert, and send it as an offer to the expert. In this sense, the user will earn an income together with the expert and other users depending on how many times the answer to the question is previewed. Users can ask questions publicly and privately. However, the other users cannot view private questions and answers. When it comes to questions that are asked publicly, the other users can view the answers after paying the price and can interact with the questions; and, the income arising from the previews of other users is shared between the expert and the user asking the question according to the price offered for the question.

People who have the ability to answer questions asked by the user are called experts. The expert can see the offers for the questions submitted by the user and evaluates these offers and may approve or reject these offers or send them back as an offer to the user for re-evaluation by specifying the terms that he/she does not accept, giving suggestions that he/she can accept. Here, the expert has the freedom to see the offers of question and answer the questions under the conditions he/she wants. If the user accepts the offer returned to him/her for his/her reconsideration, he/she approves the final offer, whereafter the expert proceeds to the answering step. The expert is obliged to respond within the specified time following his/her approval of the offer for the question; otherwise, the questions that are not answered in time will be returned to the user, and a dispute proceeding will be triggered. Dispute means that there is a conflict in this process. After approving the question-and-answer offer, the expert can answer the question in writing, visual or video form, as the user wishes, and may ask for more detailed information if necessary. After preparing the answer, the expert delivers it to the user and the user, evaluating the answer.

The users' questions and responses to it by the experts will start with the agreement of the price determined by both parties. A separate wallet is defined for each user in the application. Users can deposit or withdraw amounts in/from their wallets. The user can get the essential extract of the transactions he/she has made. The user can save the bank information in his wallet and withdraw the balance in his/her wallet at intervals he/she determines. The user can save credit card information in his wallet and define a minimum balance limit for the wallet and automatically load it when it falls below the limit. After the user sends the offer for the question, payment out of the user's wallet is blocked on his/her account by the application. As the expert accepts the offer and answers the question, after a certain period time, the money paid by the user is transferred to the expert's wallet and shown on the expert's account. Where the user has a dispute with the expert about the question, if the money has not been transferred to the expert's account, the money in question is blocked by customer service using the application; however, if money has been transferred to the expert's account, the expert's account balance is blocked by the application until the dispute is resolved. The user, the expert, and the person asking the question can donate to charities and receive documents related to their donations. The user can send a bonus to the expert.

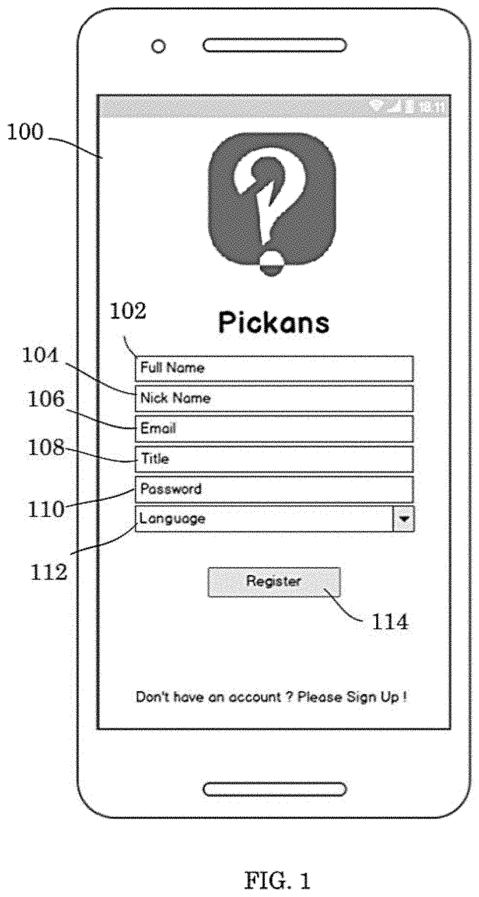

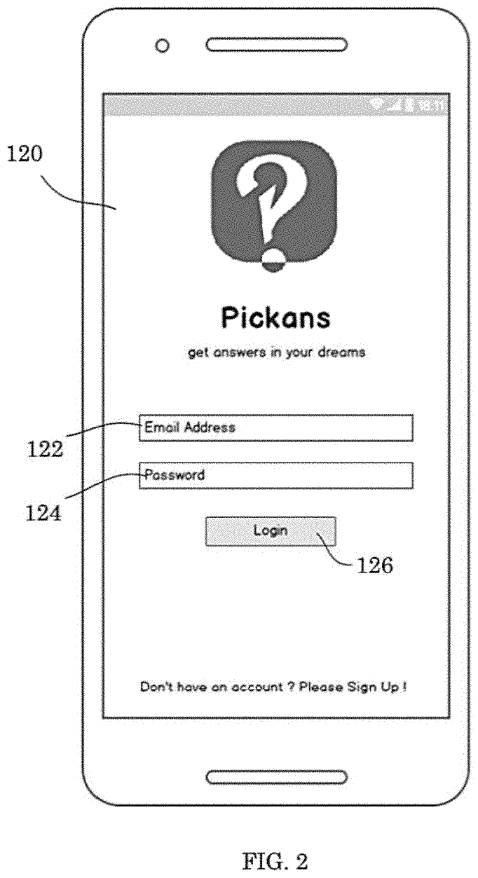

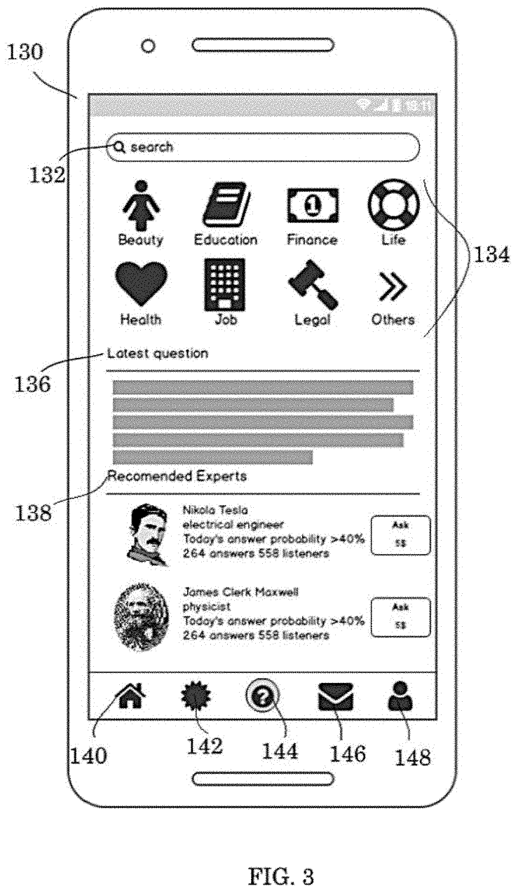

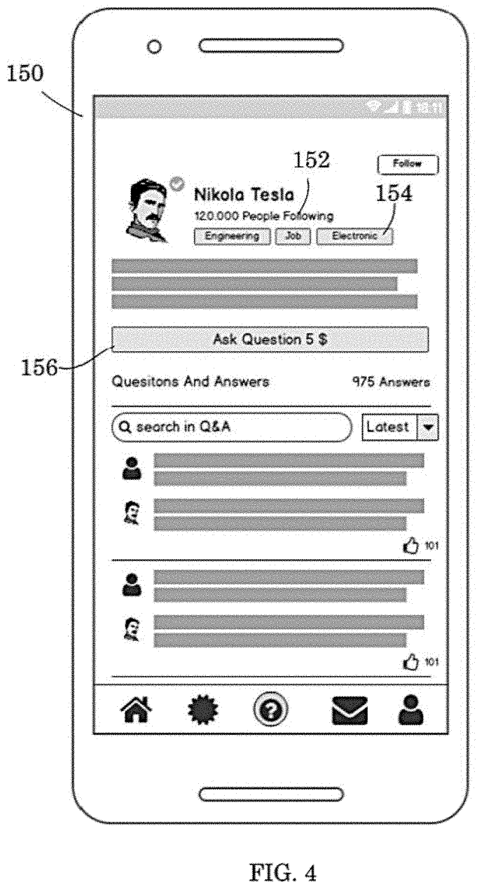

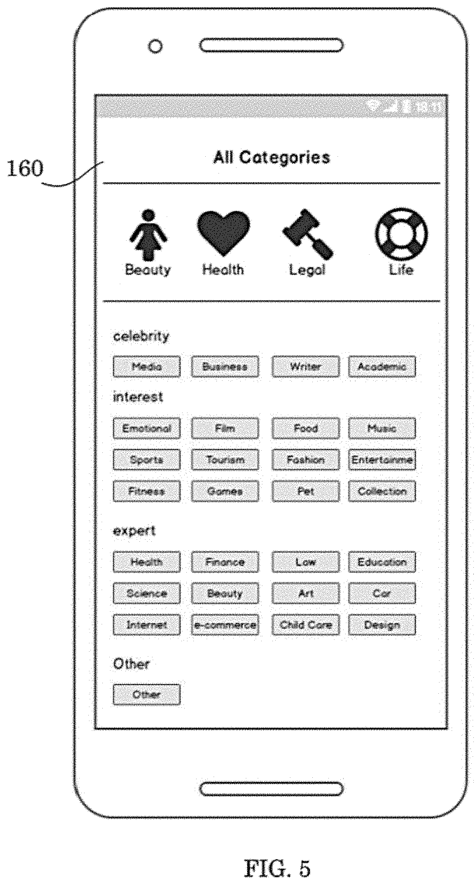

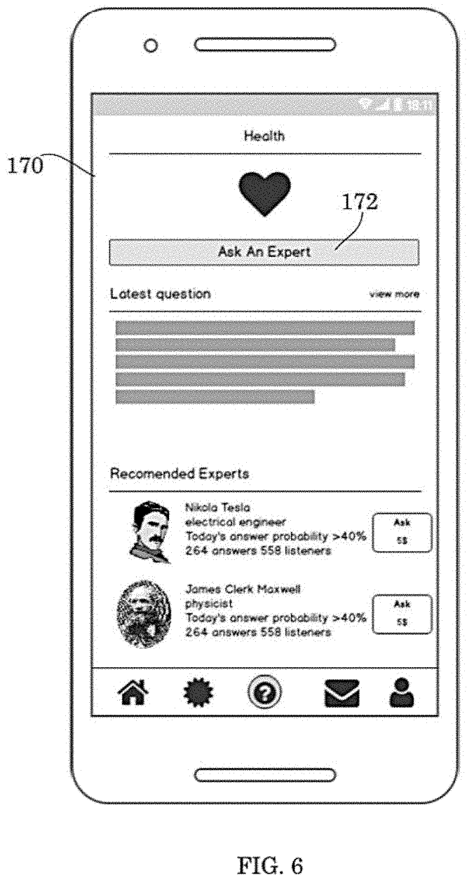

FIG. 1 is an exemplary sign-up interface (100) that enables users to sign up (register) with the application. On this interface, there is a name-surname tab (102), username tab (104), e-mail tab (106), expertise tab (108), password tab (110), language options tab (112) and sign-up (register) button (114). Service users sign up for the use of the service by reading the user agreement and by entering their name and surname, username, e-mail, area of expertise, password and language options which are all displayed on the interface. After the user signs up, verification is done by e-mail or phone. FIG. 2 is an illustration of an exemplary interface of the user login screen. After the sign-up process is verified, the login screen (120) opens and the login screen (120) contains the e-mail tab (122), the password tab (124) and the login button (126). The user can start using the application by typing his/her e-mail address and password on the login screen (120). FIG. 3 is an example interface illustration of the user's home page. The user will have search tab (132), related categories (134), last asked question tab (136), suggested experts tab (138) on the main screen (130); and home page (140), settings (142), questions (144), message (146), and profile buttons (148) on the bottom part. The user can follow or unfollow people, categories or courses. The user can edit his/her profile. FIG. 4 is an exemplary interface illustration of the expert homepage. When the user clicks on a suggested expert, the relevant expert's page (150) will be opened and the expert's information will be displayed on that page. On this expert's page (150) belonging to the expert, there is information about the areas of expertise (154) and the number of followers (152) of the expert. If the user wants to ask a question to this expert, he/she can ask the expert by clicking the “ask a question” button (156). The expert has the right to keep these answers private and make them visible to a limited number of people. The user can primarily determine the category for the question he/she wants to find an answer for and can select the relevant category by opening the page (160) for all categories. FIG. 5 and FIG. 6 show the exemplary interface for categories. If the user chooses his category, he/she can ask an expert in that category by clicking the “ask an expert” button (172) on the page that will open (170). When the user asks the expert a question and the expert approves the question-and-answer offer, the expert can answer the question in written, visual, or video form according to the user's request and may request more detailed information if necessary. After the expert prepares the answer, he/she sends it to the user, and the user evaluates the answer.

As the applications, forum sites, and the question-and-answer platforms in state of the art, where users use to find answers to their questions, do not have algorithms that allow the user who asks the question, the expert who answers, and the people who read these answers to generate income, these platforms stand as an obstacle to reaching the correct and fast answer. Experts are encouraged to respond more quickly and accurately as they derive an income from their answers. Likewise, these algorithms minimize users' doubts about the accuracy and validity of the answers given. The fact that not only those who ask and answer the question but also other users who read the answers have the opportunity to earn at certain ratios greatly increases the user's attraction and retention capacity of the application.

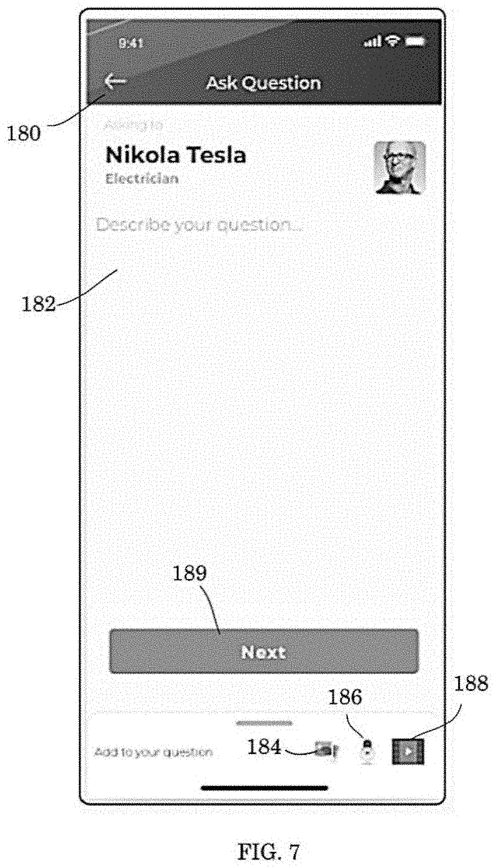

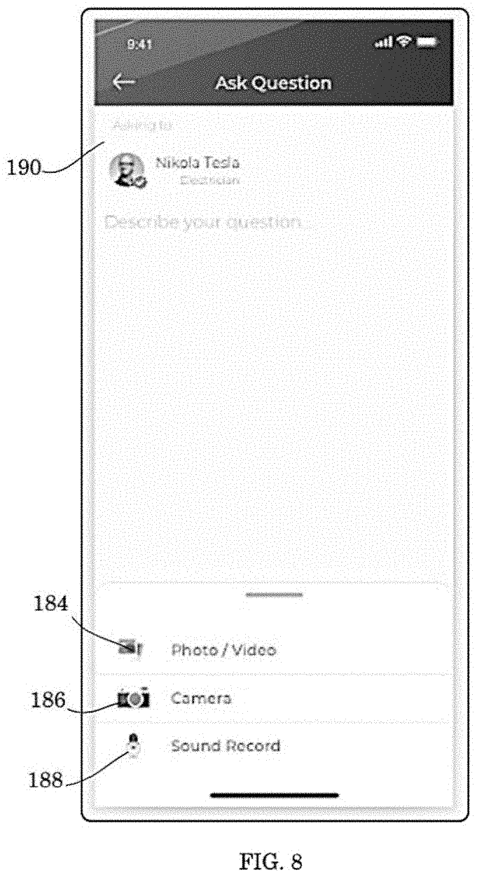

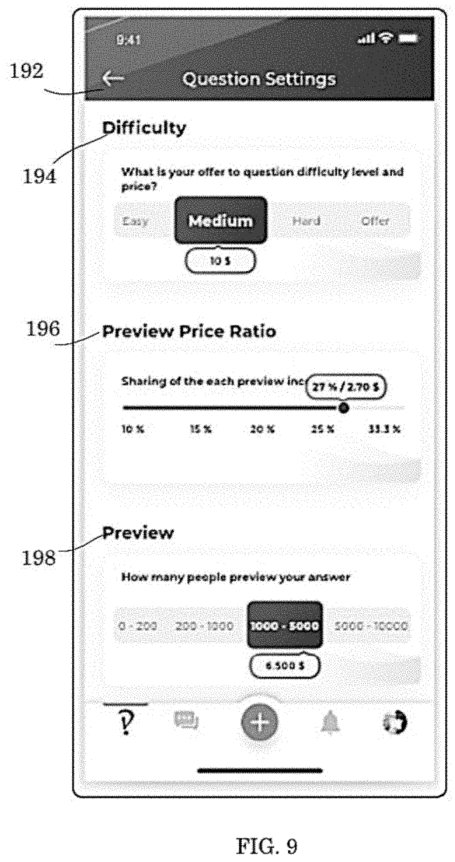

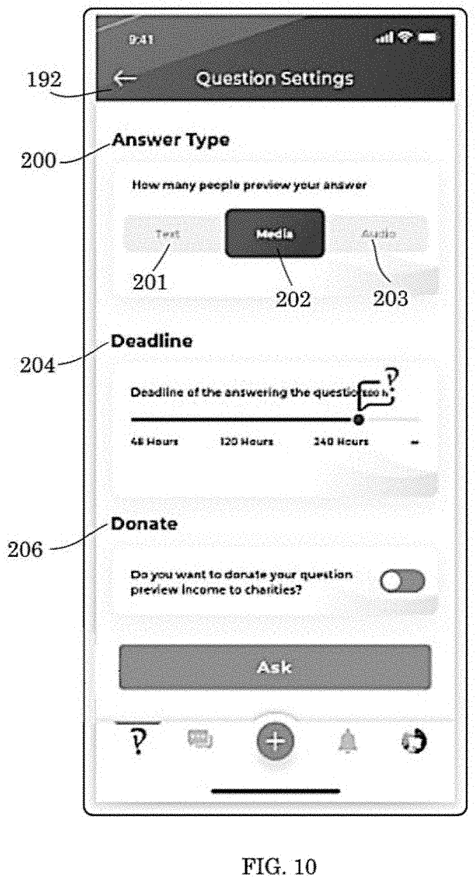

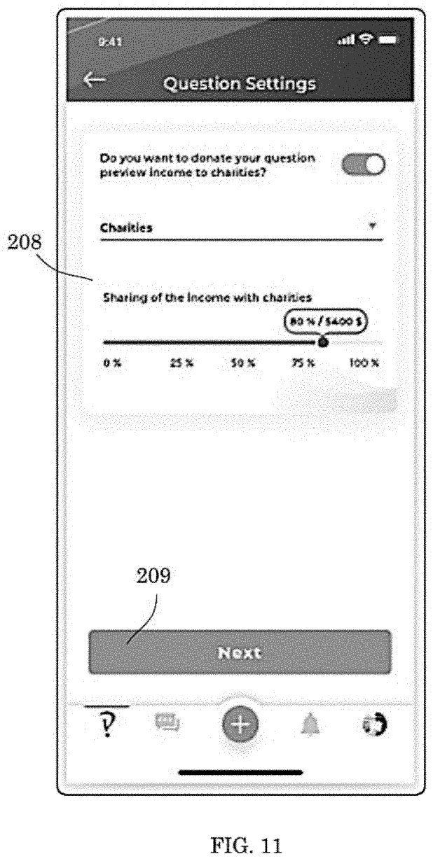

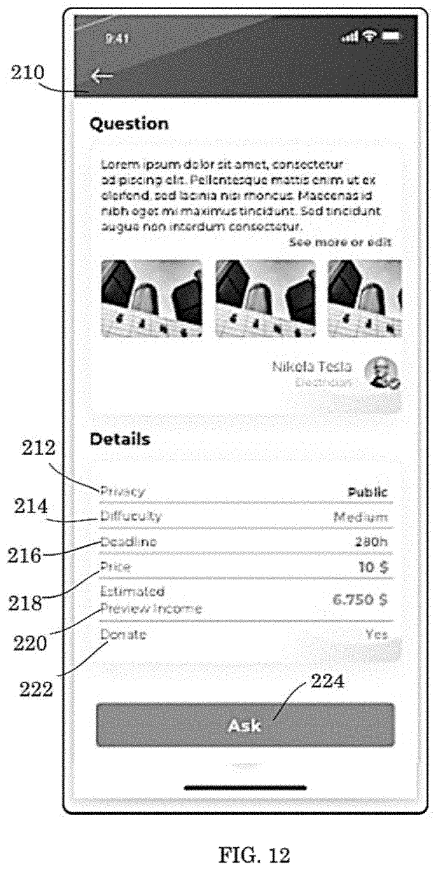

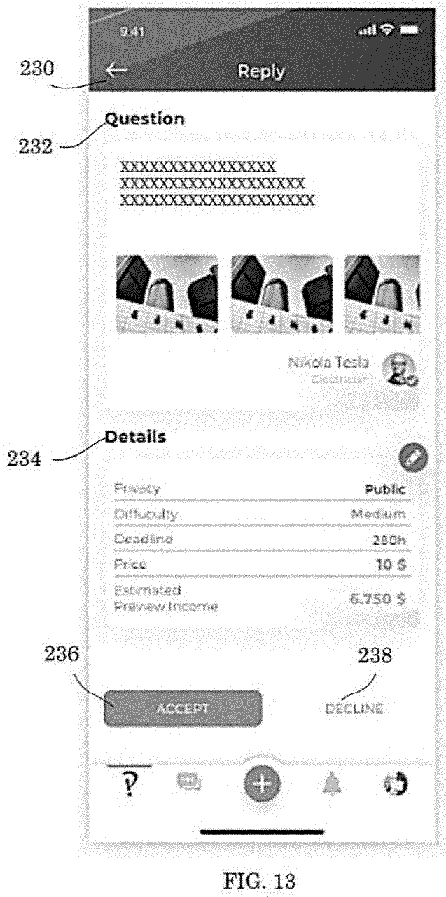

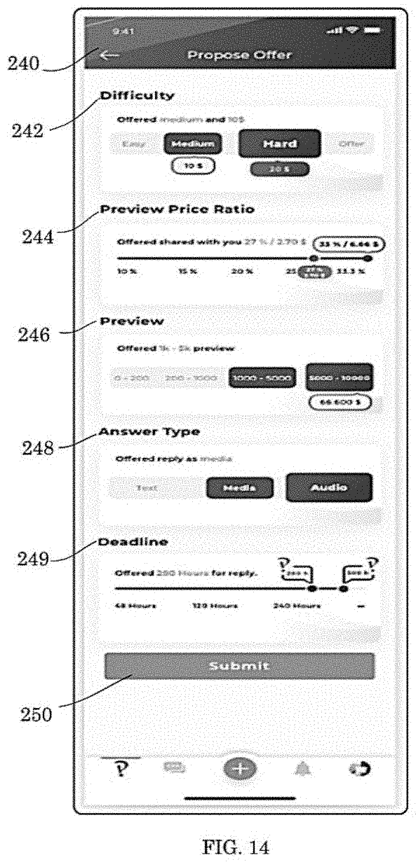

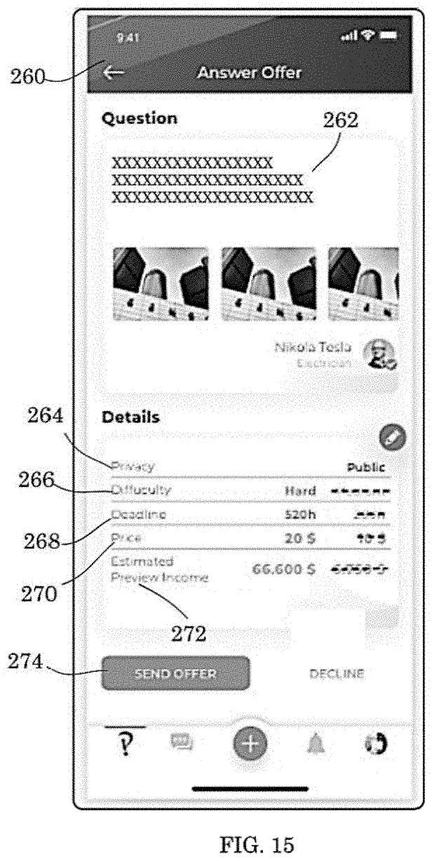

FIG. 7 is a sample illustration of the interface where the user is prompted to ask the expert a question. The user determines the expert he/she wants to ask a question, then clicks on the “Ask a question to the relevant expert” tab and writes his question (182) in the relevant space (180) on the page that opens. Users can upload photos/videos (184), camera footage (186) and audio recordings (188) while asking questions. FIG. 8 is a sample interface for the content that the user wants to add to the question. On this page (190) the user can upload photo/video (184), camera footage (186) and audio recording (188). The user enters the question settings page (192) by clicking the next button (189) on the main page (180). The user has the opportunity to edit and change the details of the question asked in the “Question Settings” (192) section. FIGS. 9,10 and 11 are an example of the question settings interface. In the question settings (192) section, the user can determine the difficulty level of the question, and a difficulty level section (194) has been created for this. The difficulty level will also determine the price for the answer. Again, in the question settings section, the user can specify the preview price ratio (196) and how many people can preview the answer (198). In the settings section, the user can also specify the form of the answer (200) he/she wants regarding the question he/she asks. He/she can request the answer in written (201), visual (202) or audio (203) form. In the deadline tab (204), the user sets the time for the answer if he/she wants the question to be answered within a certain time. The user can donate the income arising from income-sharing to the charity in the publicly asked questions. For this purpose, when the donation tab (206) is chosen, the user can mark the charity organization to which he/she wants to donate and determines at what rates (208) he/she will donate the income, which is obtained from previewing the question, to the chosen charity (208) (See FIG. 11). The user can go to the next page by pressing the next tab (209). After this step, a summary page (210) with all the questions' detail is displayed. FIG. 12 is an exemplary illustration of the interface of summary of the question of the user. Here, the user has the opportunity to see all the options related to his/her question in one place. After this process step, a summary page (210) is accessed with all the details about the question. FIG. 12 is an example illustration of the user's question summary interface. Here, the user has the opportunity to see all the options related to the question together. In detail, public or private status of the question (212), the difficulty level of the question (214), the expected time to answer (216), the price offered for the question (218), the estimated incomes (220), and the information of donating or non-donating (222) appears on a single screen. On this page, when the user clicks on the question tab (224), the offer is sent to the expert with all its details. The expert, who receives the offer for question with all its details, can evaluate the offer, approve or reject the relevant offers, specify the terms that he/she does not accept, make suggestions that he/she can accept, and send it back to the user for re-evaluation. FIG. 13 is a sample illustration of the expert's question summary interface. On the expert's screen (230), the question (232) and its details (234) appear as offers. The expert can directly accept or reject the offer on this page. Therefore, on this page, there is an approval button (236) and a rejection button (238). If the expert wishes, he/she can suggest a different offer to the user for this question. FIG. 14 is an example of the interface where the expert is set to send new offers to the user. On this page (240), the expert can change the difficulty level of the question (242) independently of the user in the offer he/she will propose. The expert can increase the income obtainable by the answer by converting the difficulty level of the question from the normal level to the difficulty level in his/her offer when he/she thinks that the question is difficult. Again, on this page, the expert can change the price ratios of previewing (244); he/she can make changes and limitations on how many people can preview the answer by his/her own choice (246). He/she can also change the answer types (248). For example, if the user wants the answer as a voice recording, the expert can make the relevant change by expressing that he/she can also answer as a text. Again, he/she can change the deadline (249) and press the presentation tab (250) with these changes. After this step, a summary page (260) containing all the details about the question is reached, where the expert will have the chance to see altogether the question (262) to which he/she will answer and all the details of his own offer regarding the question (see FIG. 15). In the section of details of FIG. 15, public or private status of the question (264), namely, viewable or not by everyone, difficulty level (266), the deadline set for the answer (268), the offered price for the question (270), estimated income (272) are displayed on a single screen. On this page, when the expert clicks on the Send Offer tab (274), then the revised offer is delivered to the user together with all its details. When the user accepts this offer, the expert notifies the user by answering the question under the conditions set in the offer. Where the user has a dispute with the expert about the question, if the money has not been shared to the expert's account, the money in question is blocked by the application. However, if money has been shared to the expert's account, the account balance is blocked by the application until the dispute is resolved.

1. An income-sharing method related to a question-and-answer system whereby service users share experiences among themselves for a price, wherein the income-sharing method comprises the following steps:
a user signing up for the question-and-answer system and choosing a category for a question of the user,
the user preparing a detailed offer and sending the question and the detailed offer to an expert, wherein the expert is a recommended expert in the category chosen by the user, or a specific expert receiving the question and the detailed offer directly from the user, wherein the detailed offer is prepared by determining a difficulty level of the question, a preview price, a preview price ratio, and a number of other users to preview an answer for the question, wherein the difficulty level determines a price to be given to the answer,
the expert accepting the detailed offer of the user as is and answering the question according to conditions determined within a scope of the detailed offer and sending the answer to the user; or
the expert, independently of the user, revising the detailed offer to a new offer by changing the difficulty level of the question, the preview price, the preview price ratio, and the number of other users able to preview the answer, and proposing the new offer to the user; if the user accepts the new offer, the expert answering the question according to conditions determined within a scope of the new offer and sending the answer to the user.

2. The income-sharing method according to claim 1, wherein the step of the user sending the question comprises the user uploading content selected from the group consisting of a photo, a video, camera footage and an audio recording, and requesting the answer in a written form, a visual form or an audio form, and publishing the question as a privately asked question or a publicly asked question.

3. The income-sharing method according to claim 1, further comprises the user setting a deadline for the answer.

4. The income-sharing method according to claim 1, wherein when the question is a publicly asked question, and the user wants to donate an income arising from the income-sharing to a charity organization, the income-sharing method further comprises the user marking the charity organization, and determining a ratio of the income to be donated to the charity organization.

5. The income-sharing method according to claim 1, wherein after the detailed offer is prepared, a preview of a public or private status of the question, the difficulty level of the question, an expected time of the answer, the price offered for the answer, estimated incomes, and donation information is viewable by the user on a single interface of a summary of the question.

6. The income-sharing method according to claim 1, wherein the step of the expert, independently of the user, revising the detailed offer comprises at least one from the group consisting of:
changing the difficulty level of the question,
increasing an income obtainable by the answer by converting the difficulty level of the question from normal to difficult when the expert thinks that the question is difficult,
changing the preview price ratio,
making changes and limitations on how many of the other users are allowed to preview the answer, and
changing a type of the answer and a deadline for the answer.

7. The income-sharing method according to claim 1, wherein after the step of the expert revising the new offer, a preview of a public or private status of the question, the difficulty level, a deadline set for the answer, the price offered for the answer, and an estimated income of the new offer are viewable by the expert on an interface of a summary of the new offer.

8. The income-sharing method according to claim 1, wherein when the question is a publicly asked question, by paying the preview price, the other users are able to preview the answer given to the question and interact with the question, and an income arising from the preview of the other users is shared between the expert and the user asking the question according to the detailed offer or the new offer accepted for the question.

9. The income-sharing method according to claim 1, wherein a wallet is defined for each of the service users, wherein
when bank information is saved in the wallet, a balance of the wallet is withdrawable at an interval determined by the each of the service users owning the wallet, and
when credit card information is saved in the wallet, a minimum balance limit is defined by the each of service users, and the minimum balance limit is automatically loaded to the wallet when the balance of the wallet falls below the minimum balance limit.

10. The income-sharing method, according to claim 1, wherein after the user sends the detailed offer or the user accepts the new offer from the expert, the price offered for the answer is blocked on an account of the user by an application; after the expert answers the question, after a predetermined period of time, money paid by the user is transferred to an account of the expert; wherein
when the user has a dispute with the expert about the question before the money is transferred to the account of the expert, the money is blocked by the application;
and
when the user has the dispute with the expert about the question after the money is shared to the account of the expert, a balance of the account of the expert is blocked by the application until the dispute is resolved.

11. An income-sharing method for a question-and-answer system, comprising:
a user sending a question and an offer to an expert chosen by the user, wherein the offer comprises a price for an answer to the question and other conditions;
the expert evaluating the offer, then the expert accepting the offer, or the expert revising the price and the other conditions in a revised offer and sending the revised offer to the user, and
once the expert and the user agree on the price for the answer and the other conditions, initiating an answering process.
